(19) United States
(12) Patent Application Publication
(10) Pub. No.: US 2008/0317045 A1
(43) Pub. Date: Dec. 25, 2008

(54) Method and System for Providing Differentiated Service

(76) Inventor: Gang Chen, Guangdong Province (CN)

Correspondence Address: LADAS & PARRY LLP, 224 SOUTH MICHIGAN AVENUE, SUITE 1600, CHICAGO, IL, 60604, US

(21) Appl. No.: 11/575,232

(22) PCT Filed: Aug. 17, 2006
(86) PCT No.: PCT/CN06/02093

§ 371 Date: Mar. 14, 2007

(30) Foreign Application Priority Data
Sep. 1, 2005 (CN) 200510093687.9

(51) Int. Cl. H04L 12/56

(52) U.S. Cl. 370/400

(57) ABSTRACT

The present invention relates to a method and a system for providing differentiated services (Diffservs). The core of the method is: determining a service level of the first hierarchy for a received service according to a type of the received service; determining a service level of the second hierarchy according to user requirements; providing service for the received service. The present invention can provide more possible QoS Diffserv levels using less resource, and can make better use of MPLS labels to provide traffic engineering service.

### FIELD OF THE INVENTION

The present invention relates to communication field, and particularly to a method and a system for providing differentiated service (Diffserv).

### BACKGROUND OF THE INVENTION

“Best Effort” communication technology based on Internet Protocol (IP) packets can not distinguish types of services in a data packet stream. With increased use of Internet, requirements for QoS(Quality of Service) better than “Best Effort” in an IP network increase significantly. For example, at present, many applications, such as voice, video stream, ERP (Enterprise Resource Planning) software, transaction-oriented E-business can work normally only when key performance parameters are guaranteed by the network.

In order to provide various services in a convergent IP network, it is necessary to provide different services with differently guaranteed QoS in an extensible and effective way.

Providing DS-TE (Differentiated service-Traffic Engineering) services in an IP network using MPLS (Multi-Protocol Label Switching) technology is attracting more and more attention. It solves the problem of differentiating different service types in a network in an extensible way, and makes specific data get better treatment than a “Best Effort” service stream gets, and allows coexistence of delay-sensitive services and general IP services. Its main principle is that a router uses a group of well-defined structure blocks to classify service streams; individual level of service streams are differentiated through networks and services according to QoS required by the classified service streams. Thus, the DS-TE allows to perform different PHB (Per Hop Behavior) according to relative service priorities allocated to service streams when data packets are forwarded. Data packets sharing the same forwarding processing share the same level of services.

Prior arts related to the present invention include two implementations of providing DS-TE service using MPLS technology: E-LSP (EXP-Inferred-PSC LSP) implementation and L-LSP (Label-Only-Inferred-PSC LSP) implementation.

The core of the E-LSP Implementation is: differentiating Diffserv levels only through 3-bit EXP in an MPLS label. The E-LSP can provide 8 Diffserv levels of QoS service at most. The Diffserv levels in the E-LSP can inherit directly from a DSCP field in an IP packet, or be given in other stream classification methods. It is a single hierarchy classification of QoS service.

The core of the L-LSP implementation is: differentiating Diffserv levels only through MPLS label values, each label specifically corresponding to a type of Diffserv. The EXP bits in an MPLS label are only used to indicate drop precedence. Each Diffserv level is determined by the stream classification method, etc., and the specific number of supported service levels only relates to the number of labels in corresponding label space. It is a single hierarchy classification of QoS service.

It can be seen from the above two implementations of providing DS-TE service using MPLS technology that prior arts are disadvantageous in that:

When the DS-TE service is provided by using the E-LSP implementation, the number of Diffserv levels provided by the E-LSP is limited, which is 8 at most.

when the DS-TE service is provided by using the L-LSP implementation, the Diffserv provided by the L-LSP does not inherit QoS service information carried in DSCP (DIFFSERV Code Point) field in an original IP packet. When multi-level Diffservs are provided, an L-LSP tunnel needs to be established for each service level of data stream, therefore large amount of system resources are occupied.

### SUMMARY OF THE INVENTION

The present invention provides a method and a system for providing Diffserv, which provide more possible QoS Diffserv levels with less resource; and make better use of MPLS labels to provide traffic engineering services.

The object of the present invention is achieved by the following technical solution:

A method for providing Diffserv according to an embodiment of the present invention includes:

A. allocating QoS (Quality of Service) service levels of different hierarchies to services according to user requirements;

B. providing corresponding Diffserv for a service based on the allocated QoS service levels of different hierarchies.

Wherein, step A includes:

A1. setting types of QoS service levels based on aDiffserv object;

A2. allocating QoS service levels of different hierarchies to the services based on the set types of QoS service levels.

Wherein, step A2 includes:

A21. classifying the services by type, and setting QoS service levels of the first hierarchy for respective types of the services based on the set types of QoS service levels according to service level requirements of the services;

A22. reclassifying the classified services of the same type according to service level requirements thereof, and setting QoS service levels of the second hierarchy for the reclassified services based on the set types of QoS service levels.

Wherein, step B includes: when an ingress node receives the service,

B1. determining, by the ingress node, type of the received service based on information of the service, and mapping the service to a Label Switching Path LSP tunnel according to the QoS service level of the first hierarchy corresponding to the type of the service, the LSP tunnel corresponding to the service level;

B2.inside the LSP tunnel, setting a corresponding MPLS(Multi-Protocol Label Switching) in-label and a EXP value corresponding to the in-label for the service according to the set QoS service levels of the second hierarchy; and

B3. providing corresponding QoS services for the service according to the EXP value.

Wherein, step B1 includes:

B11. determining, by the ingress node, type of the service according to the information of the received service;

B12. searching and obtaining the QoS service level of the first hierarchy corresponding to the type of the service from the QoS service levels of the first hierarchy corresponding to all types of services, according to the type of the service;

B13. mapping the service to the LSP tunnel corresponding to the obtained QoS service level of the first hierarchy, based on Resource Reservation Protocol-Traffic Engineering extension RSVP-TE protocol or MPLS-Traffic Engineering MPLS-TE protocol.

Wherein, step B further includes: when a transit node receives the service,

B4. providing, by the transit node, corresponding QoS services for the received service according to the in-label and EXP value of the service.

Wherein, step B further includes:

B5. determining forwarding information corresponding to the service according to the MPLS label of the service, and forwarding the service to a corresponding next hop node for processing according to the forwarding information.

Wherein, step B further includes: when an egress node receives the service,

B6. providing, by the egress node, corresponding QoS services for the service according to the in-labels and EXP values of the received service.

Wherein, step B further includes: when the egress node receives the service,

B7. determining, according to the MPLS label of the service, a pop-out label required by the service, and transmitting the service to the application layer for processing according to the determined pop-out label.

Wherein, in step B5, the information of the received service includes: Access Control List ACL strategy and/or ingress port.

The present invention also provides a system for providing Diffservs, including: an ingress node, for setting types of QoS service levels of services based on Diffserv objects according to user requirements, and for allocating QoS service levels of different hierarchies to a service based on the set types of QoS service levels; and an egress node, for providing corresponding QoS services for a service according to an MPLS in-label and EXP value of the service.

According to the present invention, QoS service levels of different hierarchies can be allocated to services according to user requirements; and corresponding Diffserv can be provided for a service according to the allocated QoS service levels of different hierarchies. The present invention has advantages of both E-LSP Implementation and L-LSP Implementation. It can provide more possible QoS Diffserv levels using less resource, and can make better use of MPLS labels to provide traffic engineering service.

### BRIEF DESCRIPTION OF THE DRAWINGS

FIG. 1 is a flow chart of a method for providing Diffservs according to an embodiment of the present invention;

FIG. 2 is a schematic diagram of a network topology structure according to an embodiment of the present invention.

### DETAILED DESCRIPTION OF THE EMBODIMENTS

The present invention provides a method for providing Diffservs, the core of which is: first, allocating QoS service levels of different hierarchies to services according to user requirements; and then, providing corresponding Diffserv for a service based on the allocated QoS service levels of different hierarchies.

According to an embodiment of the present invention, at first, a C-Type type, which is used for indicating an L-E-LSP type DIFFSERV, is added on the basis of RFC3270 5.2 DIFFSERV Object, which is defined as follows:

Class =65, C-Type = TBD

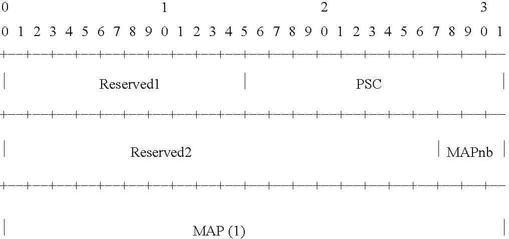

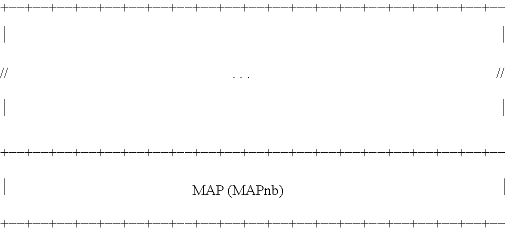

Wherein, the Reserved1 field occupies 16 bits. It is a reserved field, and must be 0.

The PSC field occupies 6 bits, indicating a local Diffserv behavior (PHB) identified by an LSP label. The PSC is encoded in the same manner as PHBID here below.

The Reserved2 field occupies 28 bits. It is a reserved field, and must be 0.

TheMAPnb field occupies 4 bits. It indicates number of MAP entries in a DIFFSERV Object and ranges from 0 to 8.

The MAP field occupies 32 bits. Each MAP entry defines a mapping relationship between the EXP bits and the local Diffserv behavior (PHB). A format of the MAP entry is:

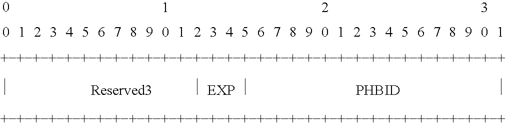

Wherein, the Reserved3 field occupies 13 bits. It is a reserved field, and must be 0.

The EXP field occupies 3 bits. It is an EXP value in the mapping relationship of the MAP entry.

The PHBID field occupies 16 bits. It is an identifier value of the local Diffserv behavior (PHB) in the mapping relationship of the MAP entry.

Based on the above definition, a system for providing Diffservs according to an embodiment of the present invention includes: an ingress node, which sets types of QoS service levels of services based on Diffserv objects according to user requirements, and allocates QoS service levels of different hierarchies to services based on the set types of QoS service levels; and an egress node, which provides corresponding QoS services for the services according to an MPLS in-label and an EXP value of the service. It is appreciated that one or more transit nodes may be further included between the ingress node and the egress node.

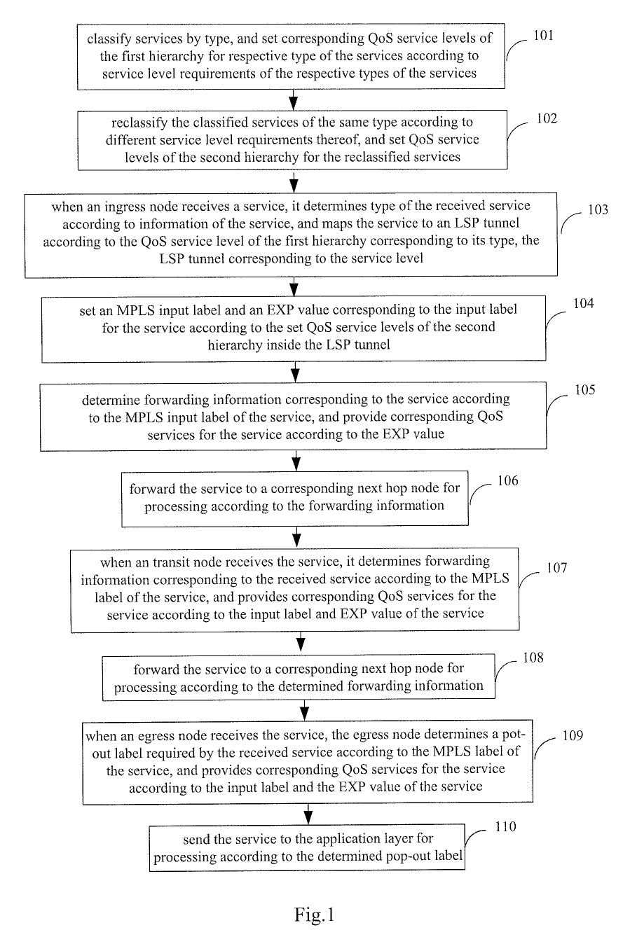

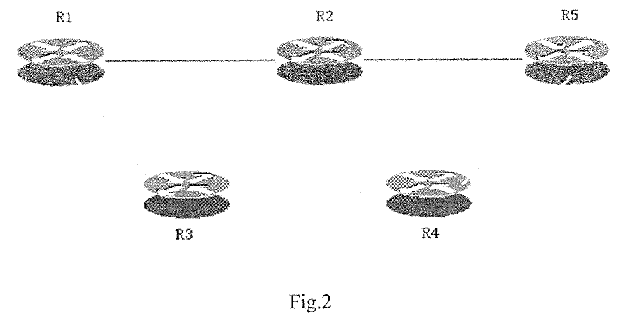

FIG. 1 shows a flow chart of a method for providing Diffservs according to an embodiment of the present invention, wherein, the method for providing Diffservs which is implemented with the network topology structure shown in FIG. 2 includes:

Step 101: classifying services by type, and setting corresponding QoS service levels of the first hierarchy for respective types of the services according to service requirements of the services;

Assuming that there currently exist three types of services: voice service, video service and data service.

First, QoS service levels of the first hierarchy are set for the three types of the services according to their types. For example, a voice service has a higher requirement for delay quality assurance, and therefore, its QoS service level is set higher than those of the other two types of services.

Step 102: reclassifying the classified services of the same type according to service level requirements thereof, and setting QoS service level of the second hierarchy for the re-classified services.

Namely, according to user requirements, the classified services are re-classified, and QoS service levels of the second hierarchy are set for the re-classified services. Take classified voice services as an example, the classified voice services are re-classified and QoS service levels of the second hierarchy are set for the reclassified voice services. The QoS service levels of the second hierarchy sequentially include, from high level to low level, e.g. gold-medal customer voice service, silver-medal customer voice service and common voice service, etc.

Through the above steps, Diffserv levels of different hierarchies are set for each service. According to an embodiment of the present invention, better Diffserv can be provided for each service based on the above set results. Here, as shown in FIG. 2, assuming that R1 is an ingress node, R2, R3, R4 are transit nodes, R5 is an egress node; it can be analyzed that if the services are transferred from R1 to R5, they will pass through either one of link R1-R2-R5 or link R1-R3-R4-R5. Assuming each link has a bandwidth of 100M, and there are two types of services: voice service and data service, and the traffics of each type of the services occupy a bandwidth of 80M.

Step 103: when the ingress node R1 receives a service (voice service, video service or data service), the ingress node R1 determines type of the received service according to information of the service, and maps the service to an LSP tunnel according to a QoS service level of the first hierarchy corresponding to the type of the service, the LSP tunnel corresponding to the service level. In the Diffserv Object, it is represented as mapping a label of the LSP tunnel to a specified PSC. The specific implementation procedure may include:

Step 1. determining, by the ingress node R1, type of the received service according to the information of the service;

Step 2. searching and obtaining the QoS service level of the first hierarchy corresponding to the service from the QoS service levels of the first hierarchy corresponding to all types of services, according to the type of the service;

Step 3. mapping the service to the LSP tunnel corresponding to the obtained QoS service level of the first hierarchy based on RSVP-TE protocol or MPLS-TE protocol.

For example, as shown in FIG. 2, at the ingress node R1, a router firstly determines types of services according to information of received packets (such as ACL strategy, in-port, etc.). When it is confirmed that there is only one type of services, such as a voice service, or a data service, it maps the service to the corresponding LSP tunnel of R1-R2-R5 according to the QoS service level of the first hierarchy corresponding to the service.

When it is confirmed that there are two types of services, e.g., a voice service and a data service, first, the services are classified. Since the QoS service level of the first hierarchy of voice service is set higher than that of data service, the voice service is mapped to the corresponding LSP tunnel of R1-R2-R5, i.e., the shortest path R1-R2-R5 is selected to establish the LSP tunnel for the voice service. The established LSP is named LSP125, and is mapped to DIFFSERV service PSC1 in the DIFFSERV Object. Then, it is determined whether the bandwidth of the R1-R2-R5 tunnel still can meet transmission requirement of the data service, and if yes, the data service is also mapped to the tunnel of R1-R2-R5; or if not, the data service is mapped to the LSP tunnel of R1-R3-R4-R5, i.e., the idle path R1-R3-R4-R5 is selected to establish the LSP tunnel for the data service. In this example, since the bandwidth of the shortest path R1-R2-R5 is not enough to transmit the 80M data service after allocating 80M bandwidth to the voice service, the idle path R1-R3-R4-R5 is selected as a path to establish the LSP tunnel for the data service. The established LSP is named LSP1345, and is mapped to DIFFSERV service PSC2 in the DIFFSERV Object.

Step 104: inside the LSP (LSP125 or LSP1345) tunnel, setting a corresponding MPLS (multi-protocol label switch) in-label and a EXP (Experiment) value corresponding to the in-label for a corresponding service, according to the set QoS service levels of the second hierarchy.

Take a voice service as an example, the service level of the voice service, such as gold medal service, silver medal service or common service, is mapped to one of different EXP values of the MPLS in-label of the ingress node R1. The EXP bits respectively correspond to the PHBIDs in the DIFFSERV Object in order to correspond to the set DIFFSERV service levels of the second hierarchy. Then, the LSP label is mapped to the corresponding service level by means of RSVP-TE protocol, wherein, the DIFFSERV Object in RSVP signaling specifies: Class=65, C-type=TBD(to be determined), the value of PSC is PSC1, and three service levels of the second hierarchy CT1, CT2 and CT3 correspond to EXP1+PHBID1, EXP2+PHBID2, EXP3+PHBID3 in the DIFFSERV Object, respectively. The individual nodes passed through by RSVP protocol packets can each at the node itself map the LSP label to the corresponding service level according to the DIFFSERV Object.

For data traffic, similar to the case of voice traffic, when LSP1345 is established via the path R1-R3-R4-R5, three types of inner QoS level services are mapped to different EXP bits of the LSP label, corresponding to PHBIDs representing different DIFFSERV services. Then, similar to the case of voice traffic, the LSP tunnel is established using RSVP-TE protocol, wherein, the DIFFSERV Object indicates PSCs and PHBIDs mapped to individual service levels.

Step 105: for each of the services, determining forwarding information corresponding to the service according to the MPLS in-label of the service, and providing corresponding QoS services for the service according to the EXP value corresponding to the service.

The Behavior action corresponding to the packets of the service is obtained according to the EXP value, and QoS level service assurance process is carried out at R1, and the forwarding information corresponding to the service is determined according to the MPLS in-label of the service.

Step 106: forwarding the service to a corresponding next hop node for processing according to the forwarding information.

When receiving the service, the transit node performs step 107 and step 108

Wherein, step 107: the transit node determines forwarding information corresponding to the received service according to the MPLS label of the service, and provides corresponding QoS services for the service according to the in-label and the EXP value of the service.

Step 108: forwarding the service to a corresponding next hop node for processing according to the determined forwarding information.

Also as shown in FIG. 2, in the above step 107 and step 108, at the transit nodes (R2, R3, R4), the router determines the forwarding information, such as out-label, next hop, etc., corresponding to the received service according to the MPLS label of the service; and at the same time, it obtains a QoS service Behavior corresponding to the packets according to the in-label+the EXP bits. After being processed for QoS level service assurance at the router, the service is forwarded to a next hop router.

When an egress node receives the service, it performs step 109, i.e., the egress node determines a pop-out label required by the received service according to the MPLS label of the service, and provides corresponding QoS services for the service according to the in-label and the EXP value of the service.

Step 110: sending the service to the application layer for processing according to the determined pop-out label.

That is to say, at the egress node R5, the router determines the pop-out label required by the service according to the MPLS label of the received packets, and at the same time, it obtains the QoS service Behavior corresponding to the packets according to the in-label+the EXP bits. At the router, the service is processed for QoS level service assurance, for subsequent forwarding process.

According to the embodiments of the present invention, QoS service levels of different hierarchies can be allocated to services according to user requirements; and corresponding Diffservs can be provided for services according to the allocated QoS service levels of different hierarchies. The embodiments of the present invention have advantages of both E-LSP Implementation and L-LSP Implementation. It can provide more possible QoS Diffserv levels using less resource, can utilize flexibly information carried in DSCP field of IP packets, and can make better use of MPLS labels to provide traffic engineering service.

Though the present invention has been illustrated and described by referring to some preferred embodiments of the present invention, those skilled in the art should understand that various changes may be made in form and detail without departing from the spirit and the scope of the present invention and therefore should be covered in the protection scope of the present invention defined by the appended claims and its equivalents.

1-13. (canceled)

14. A method for providing differentiated services, comprising:
determining a service level of the first hierarchy for a received service according to a type of the received service;
determining a service level of the second hierarchy for the received service according to user requirements;
providing differentiated services for the received service according to the service levels of the first hierarchy and the second hierarchy.

15. The method of claim 14, wherein, the determining a service level of the first hierarchy for a received service according to a type of the received service comprises:
according to a service level of the first hierarchy corresponding to the type of the received service, mapping the received service to an LSP (Label Switching Path) tunnel according to the service level of the first hierarchy.

16. The method of claim 15, wherein, the determining a service level of the second hierarchy for the received service according to user requirements is implemented with the following steps of:
according to a service level of the second hierarchy corresponding to the user requirements, inside the LSP tunnel, setting a corresponding MPLS(Multi-Protocol Label Switching) in-label and an EXP value corresponding to the in-label.

17. The method of claim 16, wherein, the providing differentiated services for the received service is implemented with the following steps of:
providing service for the received service according to the set MPLS in-label and the EXP value.

18. An ingress device for providing differentiated services, comprising:
a first hierarchy module for determining a service level of the first hierarchy for a received service according to a type of the received service;
a second hierarchy module for determining a service level of the second hierarchy for the received service according to user requirements;
a service providing module for providing differentiated services for the received service according to the service levels of the first hierarchy and the second hierarchy.

19. The ingress device of claim 18, wherein, the first hierarchy module, according to a service level of the first hierarchy corresponding to the type of the received service, mapping the received service to an LSP (Label Switching Path) tunnel according to the service level of the first hierarchy.

20. The ingress device of claim 19, wherein, the second hierarchy module, according to a service level of the second hierarchy corresponding to the user requirements, inside the LSP tunnel, setting a corresponding MPLS(Multi-Protocol Label Switching) in-label and an EXP value corresponding to the in-label.

21. The ingress device of claim 20, wherein, the first service level and the second service level are set based on a Diffserv object.

22. A system for providing differentiated services, comprising:
an ingress node for determining a service level of the first hierarchy for a received service according to a type of the received service; determining a service level of the second hierarchy for the received service according to user requirements;
an egress node for providing differentiated services for the received service according to the service levels of the first hierarchy and the second hierarchy.

23. A system of claim 22, wherein, the ingress node further comprising:
a first hierarchy module, according to a service level of the first hierarchy corresponding to the type of the received service, mapping the received service to an LSP (Label Switching Path) tunnel according to the service level of the first hierarchy;
a second hierarchy module, according to a service level of the second hierarchy corresponding to the user requirements, inside the LSP tunnel, setting a corresponding MPLS(Multi-Protocol Label Switching) in-label and an EXP value corresponding to the in-label.

24. The method of claim 23, wherein, the egress node providing differentiated services for the received service according to the set MPLS in-label and the EXP value.

25. The system of claim 23, further comprising:
transit node(s), between the ingress node and the egress node, for providing differentiated services for the received service according to the set MPLS in-label and the EXP value.
